(19) United States
(12) Patent Application Publication
(10) Pub. No.: US 2026/0099663 A1
(43) Pub. Date: Apr. 9, 2026

(54) CARTGPT: Improving CART Captioning Using Large Language Models

(71) Applicant: REGENTS OF THE UNIVERSITY OF MICHIGAN, Ann Arbor, MI (US)

(72) Inventors: Liang-yuan Wu, Ann Arbor, MI (US); Dhruv Jain, Ann Arbor, MI (US)

(21) Appl. No.: 19/349,821

(22) Filed: Oct. 3, 2025

Related U.S. Application Data
(60) Provisional application No. 63/703,699, filed on Oct. 4, 2024.

(51) Int. Cl. G06F 40/166; G06F 40/194; G06F 40/289

(52) U.S. Cl. CPC G06F 40/166; G06F 40/194; G06F 40/289

(57) ABSTRACT

Systems and methods to generate corrected Communication Access Real-time Translation (CART) captions are provided herein. The systems and methods may include receiving, an uncorrected CART transcript and an automatic speech recognition (ASR) transcript. The uncorrected CART transcript and ASR transcript may be aligned by segmenting the uncorrected CART transcript and ASR transcript into clauses, segmenting the clauses, and determining similarity values between the plurality of the CART transcript clauses and the ASR transcript clauses, with alignment of the uncorrected CART transcript and ASR transcript based on the similarity values. Errors in the uncorrected CART transcript may be detected and replaced with placeholder characters. The uncorrected CART transcript, the ASR transcript, and a prompt including context may be provided to a large language model (LLM) to generate a corrected CART transcript. Non-error substitutions may be removed from the corrected CART transcript, and the corrected CART transcript may be displayed.

### TECHNICAL FIELD

The present disclosure generally relates to captioning technology, and more particularly to computer-implemented systems and methods for enhancing Communication Access Real-time Translation (CART) technology with automatic speech recognition (ASR) and large language models (LLMs).

### BACKGROUND

Speech-to-text technologies exist to provide spoken information access to deaf and hard of hearing (DHH) people. Communication Access Real-time Translation (CART), also known as real-time captioning, is one such tool and offer accurate transcriptions of spoken content. While CART generally provides accurate transcriptions, the accuracy and reliability of CART can degrade due to rapid speech, noisy environments, and/or when speech includes highly technical topics.

Another speech-to-text technology includes automatic speech recognition (ASR). However, ASR technology is generally less accurate than CART. Additionally, ASR transcriptions fail to account for context such as speaker names, tone, gestures, audio other than speech, etc.

Thus, there exist opportunities for improving speech-to-text technologies.

### SUMMARY

The present embodiments relate to systems and methods for generating corrected communication access real time translation captions.

In one embodiment, a method for real-time correction of communication access real time translation (CART) captions includes: (1) receiving an uncorrected CART transcript and an automatic speech recognition (ASR) transcript; (2) segmenting, by the one or more processors, the uncorrected CART transcript into a plurality of CART transcript clauses and the ASR transcript into a plurality of ASR transcript clauses; (3) embedding the plurality of CART transcript clauses and the plurality of ASR transcript clauses; (4) determining similarity values between the plurality of the CART transcript clauses and the plurality of the ASR transcript clauses; (5) aligning the plurality of the CART transcript clauses with the plurality of the ASR transcript clauses based on the similarity values; (6) detecting an error in the uncorrected CART transcript; (7) replacing the error in the uncorrected CART transcript with a placeholder character; (8) providing the uncorrected CART transcript, the ASR transcript, and a prompt including context to a large language model (LLM) to generate a corrected CART transcript by replacing the placeholder character based on the ASR transcript, the alignment of the CART transcript clauses with the plurality of the ASR transcript clauses, and the context; (9) removing, by the one or more processors, one or more non-error substitutions in the corrected CART transcript; and (10) displaying, by the one or more processors, the corrected CART transcript.

In another embodiment, a method for real-time correction of communication access real time translation (CART) captions includes one or more processors; and one or more memories having stored thereon computer-executable instructions that, when executed by the one or more processors, cause the computing system to: (1) receive an uncorrected CART transcript and an automatic speech recognition (ASR) transcript; (2) segment the uncorrected CART transcript into a plurality of CART transcript clauses and the ASR transcript into a plurality of ASR transcript clauses; (3) embed the plurality of CART transcript clauses and the plurality of ASR transcript clauses; (4) determine similarity values between the plurality of the CART transcript clauses and the plurality of the ASR transcript clauses; (5) align the plurality of the CART transcript clauses with the plurality of the ASR transcript clauses based on the similarity values; (6) detect an error in the uncorrected CART transcript; (7) replace the error in the uncorrected CART transcript with a placeholder character; (8) provide the uncorrected CART transcript, the ASR transcript, and a prompt including context to a large language model (LLM) to generate a corrected CART transcript by replacing the placeholder character based on the ASR transcript, the alignment of the plurality CART transcript clauses with the plurality of the ASR transcript clauses, and the context; (9) remove one or more non-error substitutions in the corrected CART transcript; and (10) display the corrected CART transcript.

In yet another embodiment, one or more non-transitory computer-readable media having stored thereon instructions that when executed, cause a computer to: (1) receive an uncorrected CART transcript and an automatic speech recognition (ASR) transcript; (2) segment the uncorrected CART transcript into a plurality of CART transcript clauses and the ASR transcript into a plurality of ASR transcript clauses; (3) embed the plurality of CART transcript clauses and the plurality of ASR transcript clauses; (4) determine similarity values between the plurality of the CART transcript clauses and the plurality of the ASR transcript clauses; (5) align the plurality of the CART transcript clauses with the plurality of the ASR transcript clauses based on the similarity values; (6) detect an error in the uncorrected CART transcript; (7) replace the error in the uncorrected CART transcript with a placeholder character; (8) provide the uncorrected CART transcript, the ASR transcript, and a prompt including context to a large language model (LLM) to generate a corrected CART transcript by replacing the placeholder character based on the ASR transcript, the alignment of the plurality CART transcript clauses with the plurality of the ASR transcript clauses, and the context; (9) remove one or more non-error substitutions in the corrected CART transcript; and (10) display the corrected CART transcript.

### BRIEF DESCRIPTION OF THE DRAWINGS

The figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing environment in which methods and systems for generated corrected CART captions, according to embodiments described herein.

FIG. 2 depicts a neural network-based model architecture, according to embodiments described herein.

FIG. 3 depicts an example of depicting generation of a corrected CART transcript, according to embodiments described herein.

FIG. 4 depicts an example graphical user interface (GUI) for formatting captions, according to embodiments described herein.

FIG. 5 depicts a flow diagram of an example method for generating corrected CART captions, according to embodiments described herein.

FIG. 6 depicts experimental results of correcting CART transcripts with an LLM.

### DETAILED DESCRIPTION

The techniques of the present disclosure relate to generating corrected CART captions.

The present techniques introduce an approach to providing more accurate real-time captions. As described above, while CART is generally accurate (e.g., over 98%, in some cases), errors may occur due to noisy environments and rapid speech, thus leading to reduced performance. Additionally, errors may occur due to captioner error, such as typos or unfamiliarity with subject matter. ASR, another speech-to-text technology, is less accurate than CART. Furthermore, latency must be taken into consideration, as captions are provided in real-time.

The present techniques improve the accuracy of CART captioning by utilizing both CART and ASR technologies, as well as large language models (LLMs). While most current research focuses on improving performance of ASR alone (e.g., via improved specialized algorithms), the techniques of the present disclosure focus on improving CART captions. The techniques of the present disclosure provide a technical improvement over conventional techniques at least by improving the accuracy of CART captions. Specifically, an LLM may use context from a CART transcript and ASR transcript to generate correct words for errors in the CART transcript. Such a technique is more accurate than CART captioning or ASR captioning alone. For example, in one study, the average accuracy of CART alone was 83.4% while the accuracy of the present techniques was 89.0%, representing a 5.6% improvement over CART. Additionally, the present techniques were significantly more accurate than ASR alone and demonstrated a 17.3% improvement over ASR. Furthermore, the present techniques aids in deciphering complex technical terminology and filling in gaps left by traditional captioning methods, thereby improving understanding and clarity in transcripts of technical discussions. For example, the present techniques produce captions 6.9% more accurate for topics such as medicine and computer science than captions produced by CART alone.

The present techniques also consider and effectively manage latency concerns while keeping a high degree of accuracy. However, the present techniques introduce only a minimal correction delay (e.g., 300-400 milliseconds per segment) while retaining high accuracy. First, directly providing the CART transcript and ASR transcript to the LLM may produce less accurate results due to differences in timing between CART and ASR, thus leading to inaccurate context. The present techniques resolve this issue by aligning the CART transcript and ASR transcript, e.g., prior to provisioning the CART transcript and ASR transcript to the LLM. However, any additional processing leads to additional delay in displaying captions. Thus, to minimize latency, the present techniques utilize unique alignment techniques that efficiently and accurately identify related text while utilizing minimal computing resources, such as lightweight semantic matching. Additionally, processing the CART transcript with an LLM introduces additional delay in providing captions. The amount of delay produced by the processing time of the LLM may increase with greater amounts of context provided to the LLM. However, too little context may produce less accurate results. The present techniques balance accuracy and speed by providing a limited amount of context (e.g., two paragraphs) to the LLM. Thus, the provision of the corrected CART captions is perceived as fast and close enough to being in real-time, efficiently integrating AI-enhanced corrections with live captioning.

Furthermore, one flaw of LLMs is the tendency to produce hallucinations (e.g., overcorrect), thus producing less accurate output. The present techniques mitigate inaccuracy produced by LLM-induced hallucinations via additional postprocessing steps performed on the output of the LLM. Non-error substitutions (e.g., changes in a CART transcript not necessitated by errors) may be identified and reverted, thus increasing the accuracy of the corrected CART captions.

Thus, the present disclosure describes improvements to CART captioning because the techniques efficiently and accurately generate and provide captions.

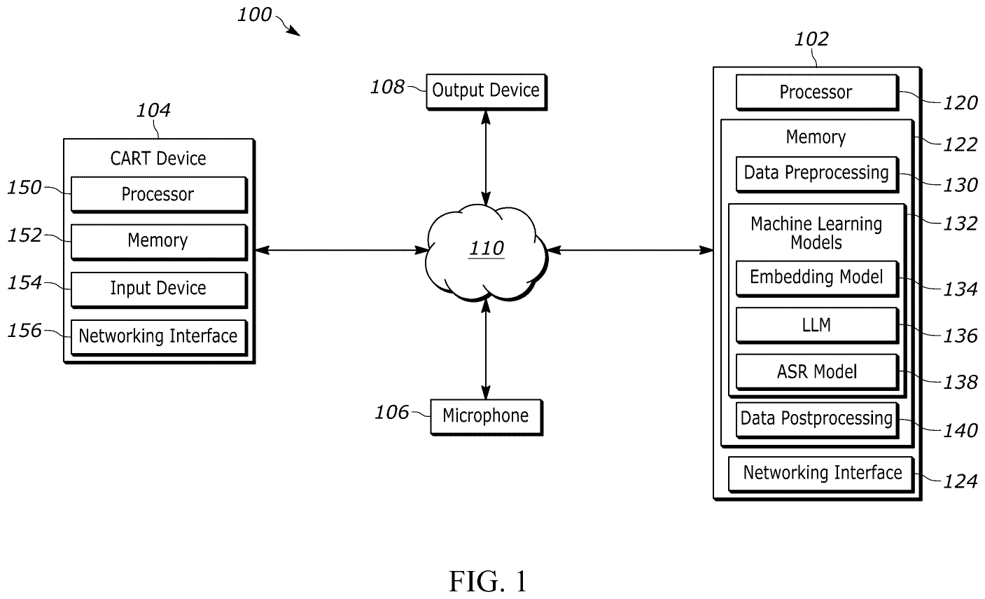

FIG. 1 depicts an example computing environment 100 for generating corrected CART captions, according to embodiments described herein. The computing environment may include a server 102, a CART device 104, a microphone 106, and an output device 108, all of which are communicatively connected by the network 110. Although FIG. 1 depicts certain entities, components, equipment, and devices, it should be appreciated that additional or alternate entities, components, equipment, and devices are also possible.

As illustrated in FIG. 1, the computing environment 100 includes, in one embodiment, at least one server 102. The server 102 may include only one server, or multiple servers that are co-located and/or remotely distributed. The server 102 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The server 102 includes processor 120, a memory 122, and a networking interface 124. In some aspects, the processor 120 may include one or more processing units, which may include, but are not limited to, CPUs, GPUs, FPGAs, ASICs, DSPs, neural processing units, RISC-V processors, coprocessors, and/or specialized processors for AI or ML-specific applications. Generally, the processor 120 is configured to execute software instructions stored in the memory 122, enabling data processing and machine learning model operations. The processor 120 is communicatively coupled to a memory 122 via a computer bus (not depicted) to create, read, update, transmit, delete, or otherwise access or interact with the data, data packets, or otherwise electronic signals to and from the processor 120 and the memory 122, e.g., in order to implement or perform the machine-readable instructions, methods, processes, elements, or limitations, as illustrated, depicted, or described for the various flowcharts, illustrations, diagrams, figures, and/or other disclosure herein. For example, the processor 120 may interface with the memory 122 via the computer bus to create, read, update, delete, or otherwise access or interact with the data received from the CART device, microphone, output device, and/or data stored in the memory 122.

The memory 122 may include both volatile and non-volatile storage mediums and may include RAM, ROM, EPROM, EEPROM, hard drives, flash memory, solid-state drives, optical drives, MicroSD cards, and others. The memory 122 may include a plurality of modules comprised of computer-executable instructions essential for the operation of the computing environment 100. These modules facilitate correction of CART transcripts to provide more accurate real-time captions for speech. The memory 122 may include a data preprocessing module 130, machine learning models 132, and a data postprocessing module 140.

The data preprocessing module 130 may include instructions to support the processing of CART and ASR transcripts to be analyzed by the machine learning models 132. In some aspects, the data preprocessing module may include instructions for aligning CART text with ASR text and detecting errors in the CART transcript.

The machine learning models 132 may include an embedding model 134, an LLM 136, and an ASR model 138. The embedding model 134 may encode each clause of the CART and ASR transcript into a numerical representation for processing and analysis as part of the data preprocessing (e.g., text alignment). The embedding model 134 may be a model such as MiniLM, SBERT, DistilBERT, etc. The LLM 136 may correct errors detected in the CART transcript by generating plausible replacement words for detected errors based on the ASR transcript and context from the CART transcript. The ASR model 138 may include a machine learning model trained to convert speech audio into text (e.g., Whisper). For example, the ASR model 138 may utilize a deep learning architecture (e.g., a neural network), to convert spoken language into text, and may be trained on a large dataset of spoken audio paired with corresponding text to learn the mapping between audio features and text output. This training process may involve optimizing the model's parameters through backpropagation and gradient descent to minimize the difference between the predicted text and the actual transcriptions in the training dataset.

The ASR model 138 may take raw audio input as its primary input source. The audio input may be processed using signal processing techniques to extract relevant features, such as spectrogram representations, which capture the acoustic characteristics of the audio signal. The extracted audio features are then fed into the neural network, which includes multiple layers of neurons that process the input data. The network learns to identify patterns in the audio features that correspond to different phonemes, words, and sentences. The ASR model 138 may use the learned parameters to decode the input audio and generate the corresponding text output. The model may consider the context of the audio input and uses its learned knowledge of language patterns to produce accurate transcriptions.

The data postprocessing module 140 may include instructions to support processing of the corrected CART transcript. In some aspects, the data postprocessing module 140 may include instructions to correct non-error substitutions (e.g., remove hallucinations) inserted by the LLM 136. For example, the processor 150 may include instructions (e.g., via a WordPiece tokenizer) to compare a corrected CART transcript to an original CART transcript. The data postprocessing module 140 may also include instructions to format the appearance of the transcript when displayed as captions on the output device 108.

The networking interface 124 may facilitate bidirectional and multiplexed networking over one or more communication networks, such as LANs and WANs, including the Internet, enabling the server 102 to communicate and share data across different locations and components within the computing environment 100.

The computing environment 100 may include a CART device 104. The CART device 104 may comprise a computing device that a CART captioner may interact with to provide the CART transcript. As used herein, “CART device” refers to any device capable of performing CART functions, whether alone or in combination with other devices, such as a CART capable architecture distributed across computing devices. Example “CART devices” include personal computers and/or laptops connected to a stenotype machine. may include a computer (e.g., personal computer, laptop, etc.) connected to a specialized computing device for providing captions (e.g., a stenotype machine). The CART device 104 may include a processor 150, a memory 152, an input device 154, and a networking interface 156. In some embodiments, the CART device 104 and the CART captioner may be local (e.g., at the location of the speaker). In some embodiments, the CART device 104 and CART captioner may be remote (e.g., not at the location of the speaker).

The processor 150 may include one or more processing units, which may include, but are not limited to, CPUs, GPUs, FPGAs, ASICs, DSPs, neural processing units, RISC-V processors, coprocessors, etc. Generally, the processor 150 is configured to execute software instructions stored in the memory 152, enabling data processing and machine learning model operations. The processor 150 is communicatively coupled to a memory 152 via a computer bus (not depicted) to create, read, update, transmit, delete, or otherwise access or interact with the data, data packets, or otherwise electronic signals to and from the processor 150 and the memory 152, e.g., in order to implement or perform the machine-readable instructions, methods, processes, elements, or limitations, as illustrated, depicted, or described for the various flowcharts, illustrations, diagrams, figures, and/or other disclosure herein. For example, the processor 150 may interface with the memory 152 via the computer bus to create, read, update, delete, or otherwise access or interact with input from the input device 154 and/or other data.

The memory 152 may include both volatile and non-volatile storage mediums and may include RAM, ROM, EPROM, EEPROM, hard drives, flash memory, solid-state drives, optical drives, MicroSD cards, and others. The memory 152 may include a plurality of modules comprised of computer-executable instructions essential for the operation of the CART device 104, e.g., translating inputs from the input device into text, etc.

The CART device 104 includes an input device 154. The input device 154 may include a specialized phonetic keyboard (e.g., stenotype machine) with which a captioner may interact to transcribe speech audio into text. For example, different combinations of keystrokes input to the input device 154 may represent different phonetic sounds.

The CART device 104 includes a networking interface 156. The networking interface 156 may facilitate bidirectional and multiplexed networking over one or more communication networks, such as LANs and WANs, including the Internet, enabling the server CART device 104 to communicate and share data across different locations and components (e.g., the server 102) within the computing environment 100. In some embodiments, the CART device 104 may be remote from a speaker location, and may receive speech audio via the networking interface 156 such that the CART captioner may transcribe the speech audio.

The computing environment 100 may include a microphone 106. The microphone 106 may capture speech audio at the location a speaker is talking. The microphone 106 may be connected to a computing device (not depicted) to transmit captured speech audio to another computing device (e.g., server 102, CART device 104) for further speech-to-text processing.

The computing environment 100 may include an output device 108. The output device 108 may receive corrected CART captions from the server 102 and display the corrected CART captions. The output device may be part of another computing device or be a standalone device. The output device may include a monitor, television, mobile device, headset, etc.

The electronic network 110 may be a collection of interconnected devices, and may include one or more local area networks, wide area networks, subnets, and/or the Internet. The network 110 may include one or more networking devices such as routers, switches, etc. Each device within the network 110 may be assigned a unique identifier, such as an IP address, to facilitate communication. The network 110 may include wired (e.g., Ethernet cables) and wireless (e.g., Wi-Fi) connections. The network 110 may include a topology such as a star topology (devices connected to a central hub), a bus topology (devices connected along a single cable), a ring topology (devices connected in a circular fashion), and/or a mesh topology (devices connected to multiple other devices). The electronic network 110 may facilitate communication via one or more networking protocols, such as packet protocols (e.g., Internet Protocol (IP)) and/or application-layer protocols (e.g., HTTP, SMTP, SSH, etc.). The network 110 may perform routing and/or switching operations using routers and switches. The network 110 may include one or more firewalls, file servers and/or storage devices. The network 110 may include one or more subnetworks such as a virtual LAN (VLAN).

In operation, a speech audio may be transcribed in real-time via a CART device 104 while the speech audio is simultaneously captured by a microphone 106. The transcribed speech audio (e.g., CART transcript) may be transmitted (e.g., via the network 110) to a server 102 for corrections. The speech audio may also be transmitted to the server 102 to be converted into text (e.g., an ASR transcript) by the ASR model 138. The CART transcript and ASR transcript may be embedded into numerical representations of the text by an embedding model 134. The CART transcript and ASR transcript may be processed by the data preprocessing module 130 to align the text of the CART transcript and ASR transcript, detect errors, and/or replace errors with placeholder characters. After the CART transcript and ASR transcript have been processed by the data preprocessing module 130, they may be provided to an LLM 136 with context and a prompt to correct the CART transcript. The LLM 136 may generate a corrected CART transcript. The corrected CART transcript may be processed by a data postprocessing module 140 to remove changes made to the CART transcript not necessitated by any errors (i.e., non-error substitutions) and formatted. The corrected and formatted CART transcript may be transmitted (e.g., via the network 110) to an output device 108 to be displayed as captions.

The computing environment 100 may include additional, fewer, and/or alternate components, and may be configured to perform additional, fewer, or alternate actions, including components/actions described herein. For instance, rather than the microphone 106 transmitting speech audio to a server 102 for ASR (e.g., via an ASR model 138), the microphone 106 may be connected to a device that performs ASR locally (e.g., at a location of the speaker). Moreover, it should be appreciated that additional and/or alternative connections between components shown in FIG. 1 may be implemented.

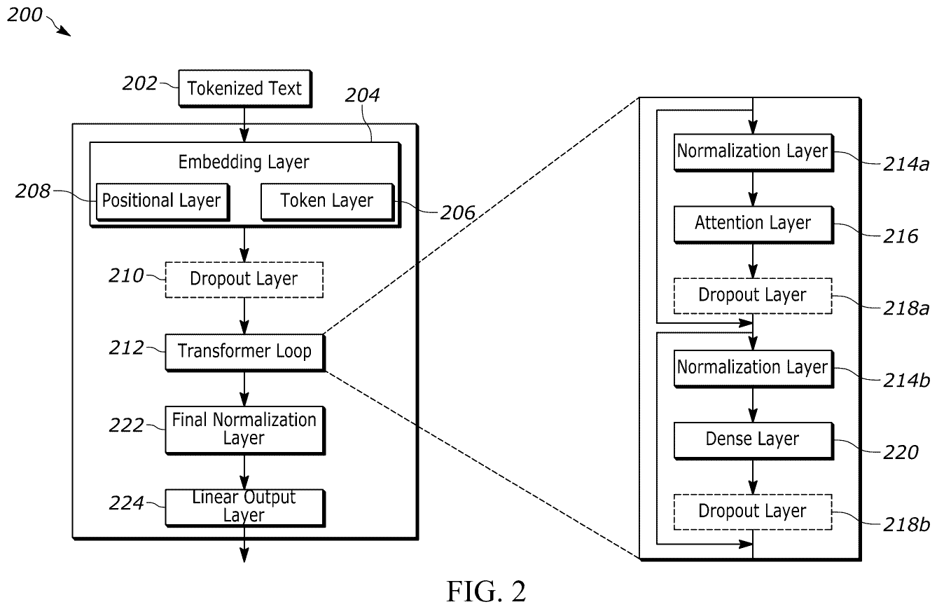

FIG. 2 illustrates a neural network-based model architecture forming the basis of LLMs such as the machine learning models 132.

Initially, the collected data may be processed through preprocessing layers, which may help the model understand the significance of each data point within the given context (e.g., two paragraphs of a CART transcript). Collected text data may first be broken down into smaller units (tokens) to generated tokenized text 202 in a tokenization process, which can be words, subwords, or characters, depending on the desired granularity and the specific tokenizer used. Special tokens like [CLS] (for classification) and [September] (sentence separation) are often added during tokenization to provide structural information to the model. The tokenized text 202 may then be passed through an embedding layer 204. The embedding layer may include a token layer 206 to convert the tokens into vectors, and positional layer 208 to provide information about the relative or absolution position of elements in the input data. The embedding layer 204 may create embeddings by representing each token as a numerical vector that captures its semantic meaning. The aforementioned layers may be followed by a dropout layer 210 to prevent overfitting. As such, the dropout layers may ensure that the model does not become too reliant on the training data, which may allow the model to generalize more effectively to new, unseen data.

The core of the architecture is the neural network loop 212, which may be iterated N times, where N may be a positive integer. The neural network loop is where the bulk of the analysis happens. Each iteration may consist of a normalization layer 214a, followed by an attention layer 216 with its own dropout layer 218a, another normalization layer 214b, a dense layer 220, and another dropout layer 218b. The normalization layers 214a and 214b may help stabilize the learning process by separately calculating the mean and variance of activations of each layer, and then scaling and shifting the activations to have a standard normal distribution. The attention layer 216 may allow the model to prioritize the most relevant parts of the input data. The dense layers are fully connected layers that may help in learning non-linear combinations of the features. The dropout layers 218a and 218b may be used within the neural network loop 212 to prevent overfitting by randomly omitting some of the units from the layers during training to allow the model to generalize more effectively.

The process may conclude with passing the data to a final normalization layer 222 and a linear output layer 224, producing the final output from the neural network-based model. The final normalization layer 222 may ensure that the data is normalized before passing it to the linear output layer 224, which produces the output of the model.

The model architecture depicted in FIG. 2 may be used to generate corrected CART transcripts. The neural network-based architecture may facilitate the processing of diverse data through a series of layers and loops designed to understand and identify patterns in a CART transcript and ASR transcript related to detecting errors in a CART transcript, and generating words to correct the errors in the CART transcripts. In some aspects, the model may be trained and/or fine-tuned to generate corrections for CART transcripts to better fit speaker and/or user preferences, for example. The model may utilize reinforcement learning to interact with an environment and receive rewards or penalties based on the words it generates to correct the CART transcripts. For example, a speaker may provide feedback on corrected CART transcripts to the model to train the model to preserve natural speech patterns or generate more accurate words in specific domain contexts (e.g., technical terminology, medical terminology).

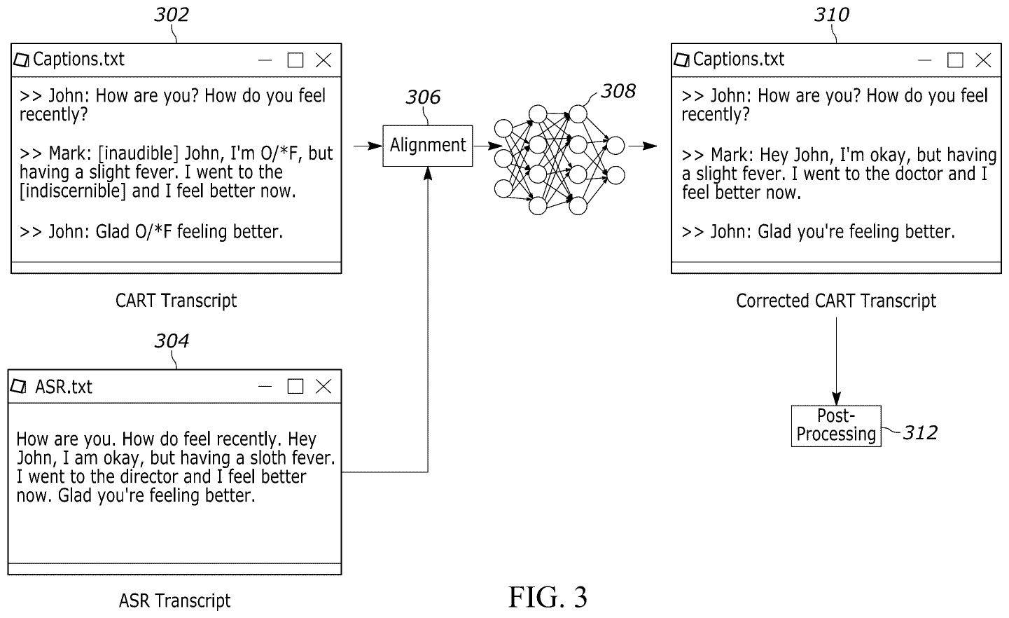

FIG. 3 depicts an example of depicting generation of a corrected CART transcript.

A captioner may transcribe speech audio in real-time via a specialized keyboard to generate the original CART transcript 302. A CART transcript may contain various types of errors due to various factors such as noisy environment, a captioner's unfamiliarity with certain words, and/or due to typos. For example, a CART transcript may include an omission error due to inaudible, unclear, rapid, and/or accented speech. An omission due to inaudible speech (e.g., from low speaker volume, microphone issues, speaker distance from captioner) may appear as “[inaudible]” in a CART transcript, while an omission due to unclear (e.g., accented or rapid) speech may appear as “[indiscernible]” in a CART transcript, as can be seen in the original CART transcript 302. A CART transcript may also include omission errors due to other factors such as background noise, or technical content, which may appear as “(?)” in the CART transcript. Omissions due to rapid speech may also be transcribed as “(?)” instead of “[indiscernible].” Another type of error may include untranslated errors, which occur due to incorrect key combinations (i.e., mistrokes) by the captioner, and may appear as adjoining capital letters or special characters. For example, “SPBRO/E” corresponds to the prefix “intro-” and will appear in a CART transcript as such, but “SPBRO/A” does not correspond to anything and will appear in a CART transcript as “SPBRO/A.” As seen in FIG. 3, the original CART transcript 302 includes a mistranslate error, which appears as “O/*F.” Yet another type of error may include mistranslate errors, which occur when a mistroke results in an actual word that is different from the word actually being said in the speech audio. Speech may continually be transcribed and transmitted while the speaker is talking.

While the original CART transcript 302 is generated, ASR may be simultaneously used to create an ASR transcript 304 of the speech audio. A microphone (e.g., microphone 106) may capture the speech audio in real-time. The speech audio may be provided to a machine learning model (e.g., the ASR model 138) to convert the audio into text to generate the ASR transcript 304. Speech audio may continually be captured and converted into text while the speaker is talking.

The original CART transcript 302 and ASR transcript 304 may undergo an alignment process 306, which may be implemented by the data preprocessing module 130 of the server 102. The alignment process 306 aligns the text of the original CART transcript 302 with the text of the ASR transcript 304. The original CART transcript 302 and ASR transcript 304 may be aligned via semantic matching, as aligning the transcripts solely based on timing may not be possible due to the differences in the latency between a CART data stream (e.g., transcription and reception of a CART transcript) and an ASR data stream (e.g., capture of the speech audio, conversion into an ASR transcript, and reception of the ASR transcript).

The alignment process 306 may include segmenting the original CART transcript 302 into different clauses (i.e., a grouping of words of the text of the CART transcript 302). The original CART transcript 302 may be segmented based on punctuation, or by explicit pause cues added by the captioner. For example, a clause may include a sentence, part of a sentence, or a word. In some aspects, the original CART transcript 302 may be segmented by sound and/or sound cues in the ASR transcript 304. For example, another machine learning model may be used to process and/or filter sound cues from the speech audio, which may be transcribed in the ASR transcript. The ASR transcript 304 may likewise be segmented into clauses similar in length to the original CART transcript 302 clauses. Each clause may be encoded (e.g., by the embedding model 134) into numerical representation (e.g., embeddings).

Matching each of the original CART transcript 302 clauses with ASR transcript 304 clauses may be determined by calculating a similarity score. For example a cosine similarity score between each original CART transcript 302 clause and ASR transcript 304 clause. A original CART transcript 302 clause may be matched with the ASR transcript 304 clause with the highest similarity score. In some aspects, the alignment process 306 may utilize greedy monotonic matching to align the original CART transcript 302 clauses and the ASR transcript 304 clauses. In some aspects, the similarity score must be above a threshold. For example, for a similarity score threshold set at 0.85, if the ASR clause most similar to a particular CART clause has a similarity score of 0.75, that ASR clause will not be deemed as matching with the ASR clause. In some aspects, if no clause meets or exceeds the similarity threshold, the clause may be flagged as unaligned. In some aspects, after a particular CART clause has been aligned with a ASR clause, the alignment process 306 may include only searching for ASR clauses that come after the aligned clause when searching for a matching ASR clause for the next clause in the original CART transcript 302. For example, once a first CART clause has been aligned with a particular ASR clause, only ASR clauses that occur after the particular ASR clause will be considered for matching with a second CART clause. In some aspects, a local window may be set, limiting the number of candidate ASR transcript clauses 304 to consider for matches, thus accounting for minor desynchronization. For example, once a first CART clause has been aligned with a particular ASR clause, only the first ten ASR transcript 304 clauses that occur after the particular ASR clause will be considered for matching with a second CART clause.

The alignment process 306 may include detecting errors in the original CART transcript 302. For example, the alignment process 306 may include detecting omission errors due to inaudible or unclear speech (e.g., appearing as “[inaudible]” or “[indiscernible]” in the CART transcript), other omission errors (e.g., appearing as “(?)” in the CART transcript), or untranslate errors (e.g., appearing as a series of capital letters and/or special characters that are not actual words). In some aspects, mistranslates may be excluded from error detection. In some aspects, the alignment process 306 may include replacing all detected errors (e.g., omission errors and untranslated errors) with a placeholder character (e.g., “[ . . . ]”) in the original CART transcript 302. In some aspects, the CART transcript 302 with the detected errors replaced by a placeholder character may be saved (e.g., in the memory 122).

The original CART transcript 302 may be provided to an LLM 308 with a prompt to correct errors in the original CART transcript 302. The prompt may include instructions and context to correct the errors in the original CART transcript 302. Prompting may include techniques such as zero-shot prompting, few-shot prompting, chain-of-thought prompting, ReAct prompting, etc. In some aspects, the context may include part of the original CART transcript 302 and the ASR transcript 304. The LLM 308 may utilize the context to learn the conversational context, thus generating more accurate corrections for the CART transcript 302. The amount of context to include may be based in part on latency and accuracy considerations. As captions are provided in real-time, the amount of time for processing context may be considered in addition to preserving accuracy of the captions. For example, in some scenarios, zero-shot prompting may be ideal to provide reduced latency where accuracy is not a great concern and/or for speech in which the topic is not complex, and extensive context is not required for accurate captions. In another example, two paragraphs of the original CART transcript 302 may be provided along with the ASR transcript to reduce latency while still providing accurate corrections. In some aspects, the amount of context may be based on topic and/or speaker changes. The prompt may be saved (e.g., in the memory 122) and included in a script that calls the LLM 308 to correct errors in the CART transcript 302.

The LLM 308 may generate replacement words for each error (i.e., each instance of the placeholder character) in the original CART transcript 302, resulting in the corrected CART transcript 310. In some aspects, the LLM 308 may generate replacement words for omission errors. For example, as seen in FIG. 3, the word that appeared as “[inaudible]” in the original CART transcript 302 may be replaced by the LLM 308 to the word “Hey” in the corrected CART transcript 310 based on context from the original CART transcript 302 and ASR transcript 304. Similarly, the word that appeared as “[indiscernible]” in the original CART transcript 302 may be replaced by the LLM 308 to the word “doctor” in the corrected CART transcript 310 based on context from the original CART transcript 302 and ASR transcript 304. In some aspects, the LLM 308 may generate replacement words for untranslate errors. For example, in the phrase “I'm O/*F” in the original CART transcript 302, the LLM 308 may replace the untranslate error “O/*F” with the word “okay” in the corrected CART transcript 310 based on context from the original CART transcript 302 and ASR transcript 304. In the phrase “Glad O/*F feeling better” in the original CART transcript 302, the LLM 308 may replace the untranslate error “O/*F” with the word “doctor” based on context from the original CART transcript 302 and ASR transcript 304.

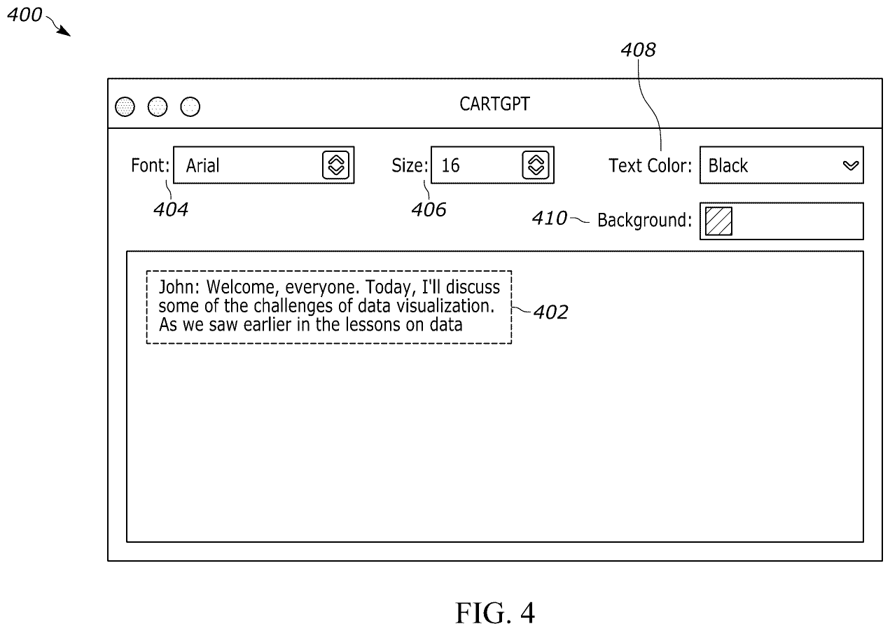

In some aspects, the original CART transcript 302 may undergo post-processing step 312 to remove any non-error substitutions (e.g., hallucinations) inserted by the LLM 308 into the CART transcript 310. The LLM 308 may insert non-error substitutions by erroneously replacing correct words (e.g., words other than the placeholder character), leading to an inaccurate CART transcript. In some aspects, to remove any potential non-error substitutions, the corrected CART transcript 310 may be compared to the original CART transcript 302. The corrected CART transcript 310 may be compared to the original CART transcript 302 at the token level to identify word changes other than corrections made to errors (e.g., any token not corresponding to an error in the original CART transcript 302). The post-processing step 312 may revert any hallucinated text in the corrected CART transcript 310 to corresponding text from the original CART transcript 302. In some aspects, the post-processing step 312 may also include formatting the corrected CART transcript 310 according to user interface preferences. For example, features such as a font, font size, text color, line length, etc. of the text in the corrected CART transcript 310 may be formatted, as depicted in FIG. 4. The text of the corrected CART transcript 310 may be transmitted to an output device (e.g., output device 108) to be displayed as real-time captions for a speaker. In some aspects, both the original CART transcript 302 and the corrected CART transcript 310 may be displayed.

FIG. 4 depicts an example graphical user interface (GUI) 400 for formatting CART transcript captions for display on a user device, according to some embodiments. Formatting of the CART transcript may be performed by a data postprocessing module 140. In some aspects, a user may interact with the GUI 400 to format the appearance of captions 402 derived from a corrected CART transcript (e.g., corrected CART transcript 310). Features such as font 404, font size 406, text color 408, and background color 410 may be formatted by a user. In some aspects, additional features (e.g., line length) may also be formatted. In some aspects, the caption formatting may be predetermined and not changeable by a user. In some aspects, formatting may include adding visual cues for corrections made by the LLM (e.g., LLM 136), such as underlining or hovering over the text to reveal the uncorrected word originally in the CART transcript. In some aspects, both the original CART transcript and the corrected CART transcript may be displayed. In some aspects, the GUI 400 may include an option to display an original CART transcript or the corrected CART transcript.

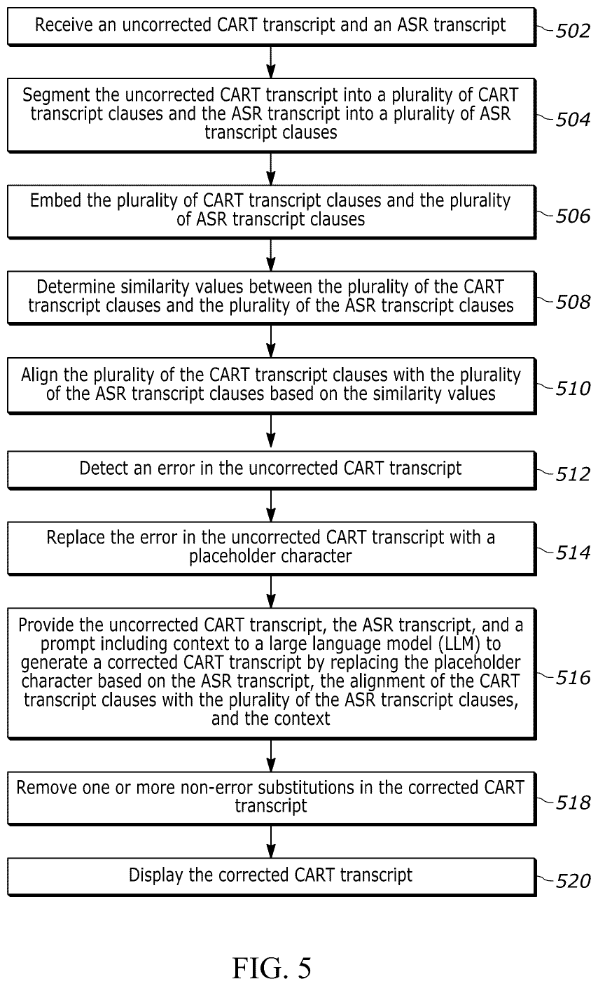

FIG. 5 depicts a flowchart of an example method 500 for correcting CART captions, according to embodiments described herein.

At block 502, the method 500 may include receiving an uncorrected CART transcript and an ASR transcript. At block 504, the method 500 may include segmenting the uncorrected CART transcript into a plurality of CART transcript clauses and the ASR transcript into a plurality of ASR transcript clauses. In some aspects, the segmenting of the uncorrected CART transcript is based on punctuation and pause cues. In some aspects, the ASR transcript may be segmented into lengths similar to those of the lengths of the uncorrected CART transcript clauses.

At block 506, the method 500 may include embedding the plurality of CART transcript clauses and the plurality of ASR transcript clauses. At block 508, the method 500 may include determining similarity values between the plurality of the CART transcript clauses and the plurality of the ASR transcript clauses to be used in aligning the plurality of the CART transcript clauses.

At block 510, the method 500 may include aligning the plurality of the CART transcript clauses with the plurality of the ASR transcript clauses based on the similarity values. In some aspects, aligning the plurality of the CART transcript clauses with the plurality of the ASR transcript clauses may include determining, at least partially based on a position in the CART transcript of each clause of the plurality of the CART transcript clauses, a subset of ASR transcript clauses from the plurality of the ASR transcript clauses. The subset of ASR transcript clauses may include only ASR transcript clauses that appear after a previously matched CART clause. The subset of ASR transcript clauses may also be restricted to a set number of clauses, e.g., the subset of ASR transcript clauses may include only the next ten clauses after a particular CART clause for which a matching ASR transcript clause has already been determined. The method 500 may include determining, based on the similarity values, a matching clause that corresponds to a particular CART transcript clause from the subset of ASR transcript clauses,

At block 512, the method 500 may include detecting an error in the uncorrected CART transcript. In some aspects, detecting the error may include detecting one or more error keywords. In some aspects, the error keywords may include at least one of “[inaudible]”, “[indiscernible]”, or “(?)”. In some aspects, the errors may include at least one of errors include at least one of an omission (e.g., indicated by the error keywords (“[inaudible]”, “[indiscernible]”, or “(?)”), or an untranslate error.

At block 514, the method 500 may include replacing the error in the uncorrected CART transcript with a placeholder character. In some aspects, replacing the error in the uncorrected CART transcript may include comparing the corrected CART transcript to the uncorrected CART transcript and detecting the one or more non-error substitutions in the corrected CART transcript. The one or more non-error substitutions may be replaced with a corresponding word from the uncorrected CART transcript.

At block 516, the method 500 may include providing the uncorrected CART transcript, the ASR transcript, and a prompt including context to a large language model (LLM) to generate a corrected CART transcript by replacing the placeholder character based on the ASR transcript, the alignment of the CART transcript clauses with the plurality of the ASR transcript clauses, and the context. In some aspects, the context includes two paragraphs of the uncorrected CART transcript preceding a paragraph containing an error of the one or more errors.

At block 518, the method 500 may include removing one or more non-error substitutions in the corrected CART transcript. At block 520, the method 500 may include displaying the corrected CART transcript.

### EXAMPLES

An experimental procedure included utilizing three CART captioners to transcribe audio files and obtaining ASR transcripts using OpenAI's Whisper model.

The audio files included a real-world speech dataset spanning multiple domains. Specifically, speech files were obtained from four publicly available benchmarks: TED-LIUM, Patient-Physician medical interviews, MIT OCW, and CallHome. These benchmarks collectively cover a wide range of domains (e.g., medicine, computer science, everyday conversation) and conversation styles (e.g., lectures, group discussions, one-on-one interactions), each accompanied by ground truth transcripts. From each benchmark, files were randomly selected to cover approximately 10 hours of content (e.g., 40 recordings from TED-LIUM, each ˜15 minutes long). In total, the final dataset spanned 39.7 hours. Table 1 summarizes the dataset composition.

TABLE 1
Dataset Composition

| | | Length per | | Total | Total |
|---|---|---|---|---|---|
| Benchmark | Description | file | | files | Hours |
| MIT OCW | Computer science lectures | 45-60 | mins | 12 | 10.2 |
| TED-LIUM | Talks on various topics | ~15 | mins | 40 | 9.9 |
| Patient- | Patient-Physician | 15-20 | mins | 36 | 9.7 |
| Physician | consultations | | | | |
| CallHome | Phone conversations | 15-30 | mins | 24 | 9.8 |

Each audio file was mixed with one of six types of environmental noise (e.g., HVAC hum, crowd babble, urban ambience, medical equipment, exhibition hall background, lecture hall acoustics) to simulate real-world conditions that may affect the accuracy of CART captioning. Each audio file included randomly sampled one noise of type with a randomly assigned a signal-to-noise ratio (SNR) of either 0 dB, 5 dB, or 10 dB.

The system was then employed to generate corrected transcripts based on the inputs from the CART transcript and ASR transcript. The procedure included, inter alia, receiving an uncorrected CART transcript (provided by the CART captioners) and an ASR transcript (provided by the Whisper model); segmenting the uncorrected CART transcript into a plurality of CART transcript clauses and the ASR transcript into a plurality of ASR transcript clauses; embedding the plurality of CART transcript clauses and the plurality of ASR transcript clauses; determining similarity values between the plurality of the CART transcript clauses and the plurality of the ASR transcript clauses; aligning the plurality of the CART transcript clauses with the plurality of the ASR transcript clauses based on the similarity values; detecting an error in the uncorrected CART transcript; replacing the error in the uncorrected CART transcript with a placeholder character; providing the uncorrected CART transcript, the ASR transcript, and a prompt including context to a large language model (LLM) to generate a corrected CART transcript by replacing the placeholder character based on the ASR transcript, the alignment of the CART transcript clauses with the plurality of the ASR transcript clauses, and the context; removing one or more non-error substitutions in the corrected CART transcript; and displaying the corrected CART transcript. Accuracy was assessed by comparing the final transcripts to ground truths, excluding non-verbal contextual cues, to determine the proportion of correctly recognized words.

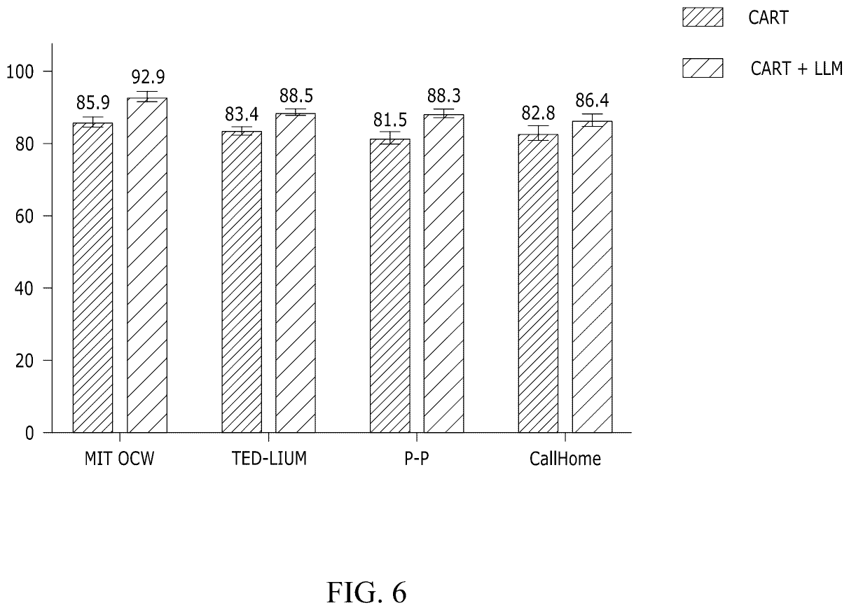

FIG. 6 depicts a graph of the experimental results. Utilizing an LLM to correct the CART transcripts produced an average accuracy of 89.0% (Word Error Rate (WER)=0.110, standard deviation (SD)=5.8%), showcasing a notable increase in accuracy when compared to utilizing CART alone (improvement of 5.6%) or the ASR model alone (improvement of 17.3%). A pairwise t-test across all transcripts yielded t₁₁=8.8, p<0.001 for corrected CART transcripts vs. uncorrected CART transcripts, and t₁₁₁=12.9, p<0.001 for corrected CART transcripts vs. ASR transcripts.

In particular, accuracy was particularly pronounced for speech including technical content, such as medical and computer science terminology. For technical topics, utilizing CART with an LLM showed an improvement of 6.9% over CART alone, whereas for more general topics (e.g., weather, food), utilizing CART with the LLM showed an improvement of 4.1% over CART alone. Additionally, the system exhibited higher accuracy gains in single-speaker lectures (improvement of 6.0%) compared to multi-person conversations (improvement of 5.2%).

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art. may be made in the arrangement, operation and details of the method and apparatus disclosed herein without departing from the spirit and scope defined in the appended claims.

What is claimed:

1. A method for real-time correction of communication access real time translation (CART) captions comprising:
receiving, by one or more processors, an uncorrected CART transcript and an automatic speech recognition (ASR) transcript;
segmenting, by the one or more processors, the uncorrected CART transcript into a plurality of CART transcript clauses and the ASR transcript into a plurality of ASR transcript clauses;
embedding, by the one or more processors, the plurality of CART transcript clauses and the plurality of ASR transcript clauses;
determining, by the one or more processors, similarity values between the plurality of the CART transcript clauses and the plurality of the ASR transcript clauses;
aligning, by the one or more processors, the plurality of the CART transcript clauses with the plurality of the ASR transcript clauses based on the similarity values;
detecting, by the one or more processors, an error in the uncorrected CART transcript;
replacing, by the one or more processors, the error in the uncorrected CART transcript with a placeholder character;
providing, by the one or more processors, the uncorrected CART transcript, the ASR transcript, and a prompt including context to a large language model (LLM) to generate a corrected CART transcript by replacing the placeholder character based on the ASR transcript, the alignment of the CART transcript clauses with the plurality of the ASR transcript clauses, and the context;
removing, by the one or more processors, one or more non-error substitutions in the corrected CART transcript; and
displaying, by the one or more processors, the corrected CART transcript.

2. The method of claim 1, wherein removing the one or more non-error substitutions includes:
comparing, by the one or more processors, the corrected CART transcript to the uncorrected CART transcript;
detecting, by the one or more processors, the one or more non-error substitutions in the corrected CART transcript; and
replacing, by the one or more processors, the one or more non-error substitutions with a corresponding word from the uncorrected CART transcript.

3. The method of claim 1, wherein detecting the one or more errors includes detecting one or more error keywords, the error keywords including at least one of: (i) “[inaudible]”, (ii) “[indiscernible]”, or (iii) “(?)”.

4. The method of claim 1, wherein the errors include at least one of: (i) an omission, or (ii) an untranslate error.

5. The method of claim 1, wherein the context includes two paragraphs of the uncorrected CART transcript preceding a paragraph containing an error of the one or more errors.

6. The method of claim 1, wherein segmenting the uncorrected CART transcript is based on punctuation and pause cues.

7. The method of claim 1, wherein aligning the plurality of the CART transcript clauses with the plurality of the ASR transcript clauses includes:
for each clause of the plurality of the CART transcript clauses:
determining, at least partially based on a position in the CART transcript of each clause of the plurality of the CART transcript clauses, a subset of ASR transcript clauses from the plurality of the ASR transcript clauses;
determining, based on the similarity values, a matching clause from the subset of ASR transcript clauses.

8. A computing system for real-time correction of communication access real time translation (CART) captions comprising:
one or more processors; and
one or more memories having stored thereon computer-executable instructions that, when executed by the one or more processors, cause the computing system to:
receive an uncorrected CART transcript and an automatic speech recognition (ASR) transcript;
segment the uncorrected CART transcript into a plurality of CART transcript clauses and the ASR transcript into a plurality of ASR transcript clauses;
embed the plurality of CART transcript clauses and the plurality of ASR transcript clauses;
determine similarity values between the plurality of the CART transcript clauses and the plurality of the ASR transcript clauses;
align the plurality of the CART transcript clauses with the plurality of the ASR transcript clauses based on the similarity values;
detect an error in the uncorrected CART transcript;
replace the error in the uncorrected CART transcript with a placeholder character;
provide the uncorrected CART transcript, the ASR transcript, and a prompt including context to a large language model (LLM) to generate a corrected CART transcript by replacing the placeholder character based on the ASR transcript, the alignment of the plurality CART transcript clauses with the plurality of the ASR transcript clauses, and the context;
remove one or more non-error substitutions in the corrected CART transcript; and
display the corrected CART transcript.

9. The computing system of claim 8, wherein removing the one or more non-error substitutions by:
comparing the corrected CART transcript to the uncorrected CART transcript;
detecting the one or more non-error substitutions in the corrected CART transcript; and
replacing the one or more non-error substitutions with a corresponding word from the uncorrected CART transcript.

10. The computing system of claim 7, wherein detecting the one or more errors includes detecting one or more error keywords.

11. The computing system of claim 7, wherein the errors include at least one of: (i) an omission, or (ii) an untranslate error.

12. The computing system of claim 7, wherein the context includes two paragraphs of the uncorrected CART transcript preceding a paragraph containing an error of the one or more errors.

13. The computing system of claim 7, wherein segmenting the uncorrected CART transcript is based on punctuation and pause cues.

14. The computing system of claim 7, wherein aligning the plurality of the CART transcript clauses with the plurality of the ASR transcript clauses includes:
for each clause of the plurality of the CART transcript clauses:
determining, at least partially based on a position in the CART transcript of each clause of the plurality of the CART transcript clauses, a subset of ASR transcript clauses from the plurality of the ASR transcript clauses;
determining, based on the similarity values, a matching clause from the subset of ASR transcript clauses.

15. One or more non-transitory computer-readable media having stored thereon instructions that when executed, cause a computer to:
receive an uncorrected CART transcript and an automatic speech recognition (ASR) transcript;
segment the uncorrected CART transcript into a plurality of CART transcript clauses and the ASR transcript into a plurality of ASR transcript clauses;
embed the plurality of CART transcript clauses and the plurality of ASR transcript clauses;
determine similarity values between the plurality of the CART transcript clauses and the plurality of the ASR transcript clauses;
align the plurality of the CART transcript clauses with the plurality of the ASR transcript clauses based on the similarity values;
detect an error in the uncorrected CART transcript;
replace the error in the uncorrected CART transcript with a placeholder character;
provide the uncorrected CART transcript, the ASR transcript, and a prompt including context to a large language model (LLM) to generate a corrected CART transcript by replacing the placeholder character based on the ASR transcript, the alignment of the plurality CART transcript clauses with the plurality of the ASR transcript clauses, and the context;
remove one or more non-error substitutions in the corrected CART transcript; and
display the corrected CART transcript.

16. The non-transitory computer-readable media of claim 15, wherein removing the one or more non-error substitutions by:
comparing the corrected CART transcript to the uncorrected CART transcript;
detecting the one or more non-error substitutions in the corrected CART transcript; and
replacing the one or more non-error substitutions with a corresponding word from the uncorrected CART transcript.

17. The non-transitory computer-readable media of claim 15, wherein detecting the one or more errors includes detecting one or more error keywords.

18. The non-transitory computer-readable media of claim 15, wherein the context includes two paragraphs of the uncorrected CART transcript preceding a paragraph containing an error of the one or more errors.

19. The non-transitory computer-readable media of claim 15, wherein segmenting the uncorrected CART transcript is based on punctuation and pause cues.

20. The non-transitory computer-readable media of claim 15, wherein aligning the plurality of the CART transcript clauses with the plurality of the ASR transcript clauses includes:
for each clause of the plurality of the CART transcript clauses:
determining, at least partially based on a position in the CART transcript of each clause of the plurality of the CART transcript clauses, a subset of ASR transcript clauses from the plurality of the ASR transcript clauses;
determining, based on the similarity values, a matching clause from the subset of ASR transcript clauses.
